(19) United States
(12) Patent Application Publication
(10) Pub. No.: US 2022/0333677 A1
(43) Pub. Date: Oct. 20, 2022

(54) BOX STRUCTURE OF SPEED REDUCER

(71) Applicant: Jing-Jin Electric Technologies (Heze) Co., Ltd., Beijing (CN)

(72) Inventors: Ping YU, Beijing (CN); Xia LIU, Beijing (CN); Lena JIN, Beijing (CN); Jianwen LI, Beijing (CN)

(21) Appl. No.: 17/764,120

(22) PCT Filed: Jul. 31, 2020
(86) PCT No.: PCT/CN2020/106233

§ 371 Date: Mar. 25, 2022

(30) Foreign Application Priority Data
Jan. 9, 2020 (CN) 202010035911.3

(51) Int. Cl. F16H 57/028; F16H 57/03; F16H 57/032

(52) U.S. Cl. CPC F16H 57/028; F16H 57/03; F16H 57/032

(57) ABSTRACT

A reducer casing structure is disclosed, which comprises a front casing, a rear casing and a connecting column; the front casing and the rear casing are sealedly connected to form therein a cavity structure for accommodating a reducer; the connecting column is provided in the cavity structure and is detachably or partially detachably connected between the front casing and the rear casing, the connection mode of the connecting column with the front casing and the rear casing is bolt connection or integrated casting, the connecting column is used to improve connection strength of the reducer casing structure, reduce casing vibration and improve NVH performance of the reducer. The reducer casing structure according to the present disclosure reduces the deformation of the front casing and the rear casing of the reducer during operation, and improves the NVH of the reducer itself or the whole power assembly; moreover, the reducer casing structure is easy to install and occupies less space.

### TECHNICAL FIELD

The present disclosure relates to the field of reducer manufacturing, in particular to a reducer casing structure.

### BACKGROUND

At present, the reducer casing of automobiles is developing in the direction of light weight. However, the weight reduction will lead to the decrease of connection strength and the increase of vibration amplitude of the reducer casing, and the increased vibration amplitude of the reducer casing during operation will affect the NVH (noise, vibration, harshness) of the reducer itself or the whole power assembly.

### SUMMARY

In view of the above problems, the present disclosure provides a reducer casing structure to solve or at least partially solve the above problems.

In order to achieve the above object, the present disclosure adopts the following technical solutions.

The present disclosure provides a reducer casing structure, comprising: a front casing, a rear casing and a connecting column;

the front casing and the rear casing are sealedly connected to form therein a cavity structure for accommodating a reducer;

the connecting column is provided in the cavity structure and is detachably or partially detachably connected between the front casing and the rear casing, the connection mode of the connecting column with the front casing and the rear casing is bolt connection or integrated casting, the connecting column is used to improve connection strength of the reducer casing structure, reduce casing vibration and improve NVH performance of the reducer.

Optionally, two ends of the connecting column are connected and fixed with the front casing and the rear casing respectively through one or more bolts.

Optionally, the connecting column is integrally cast with one of the front casing and the rear casing, and is connected and fixed with the other through one or more bolts.

Optionally, the connecting column includes at least two sections which are integrally cast with the front casing and the rear casing respectively, and the sections of the connecting column are connected and fixed to each other by one or more bolts.

Optionally, the connecting column is made of an alloy.

Optionally, the alloy is any one of alloy steel, aluminum alloy and copper alloy.

Optionally, one or more connecting columns are provided.

Optionally, the connecting column is of a stepped shape.

Optionally, the bolt is inserted into the front casing or rear casing and the connecting column from outside of the front casing or rear casing.

Optionally, the front casing and the rear casing are provided with flanges perpendicular to the front casing or the rear casing at their sealed connection, and the flanges are connected and fixed by bolts and nuts.

The above reducer casing structure has the following advantages:

The reducer casing structure according to the present disclosure, by providing a connecting column between the front casing and the rear casing, increases the connection strength of the reducer casing, effectively reduces the vibration of the reducer casing, reduces the deformation of the front casing and the rear casing of the reducer during operation, and improves the NVH of the reducer itself or the whole power assembly; moreover, the reducer casing structure is easy to install and occupies less space.

The above is only an overview of the technical solutions of the present disclosure. In order to better understand the technical means of the present disclosure so that it can be implemented according to the contents of the description, and in order to make the above and other objects, features and advantages of the present disclosure more obvious and easier to understand, the specific embodiments of the present disclosure are given below.

### BRIEF DESCRIPTION OF DRAWINGS

By reading the detailed description of the preferred embodiments below, various other advantages and benefits will become clear to a person of ordinary skill in the art. The drawings are only used for the purpose of illustrating the preferred embodiments, and should not be considered as a limitation to the present disclosure. Moreover, throughout the drawings, like reference numerals denote like components. In the drawings:

FIG. 1 is a schematic structural diagram of a reducer casing structure according to an embodiment of the present disclosure;

FIG. 2 is a schematic structural diagram of a reducer casing structure according to an embodiment of the present disclosure;

FIG. 3 is a schematic structural diagram of a reducer casing structure according to an embodiment of the present disclosure;

FIG. 4 is a schematic structural diagram of a reducer casing structure according to an embodiment of the present disclosure; and

FIG. 5 is a schematic structural diagram of a reducer casing structure according to an embodiment of the present disclosure.

In the drawings: 1. rear casing, 2. front casing, 3. connecting column, 4. bolt.

### DETAILED DESCRIPTION

Illustrative embodiments of the present disclosure will be described in more detail with reference to the drawings. Although the drawings show the illustrative embodiments of the present disclosure, it should be understood that the present disclosure can be implemented in various ways and should not be limited by the embodiments disclosed herein. On the contrary, the embodiments are provided for a more thorough and complete understanding of the present disclosure, so as to fully convey the scope of the present disclosure to those skilled in the art.

An embodiment of the present disclosure provides a reducer casing structure, which comprises: a front casing 2, a rear casing 1 and a connecting column 3.

The front casing 2 and the rear casing 1 are sealedly connected to form therein a cavity structure for accommodating a reducer. The front casing 2 and the rear casing 1 are connected through the screw holes on the outside of the front casing 2 and the rear casing 1.

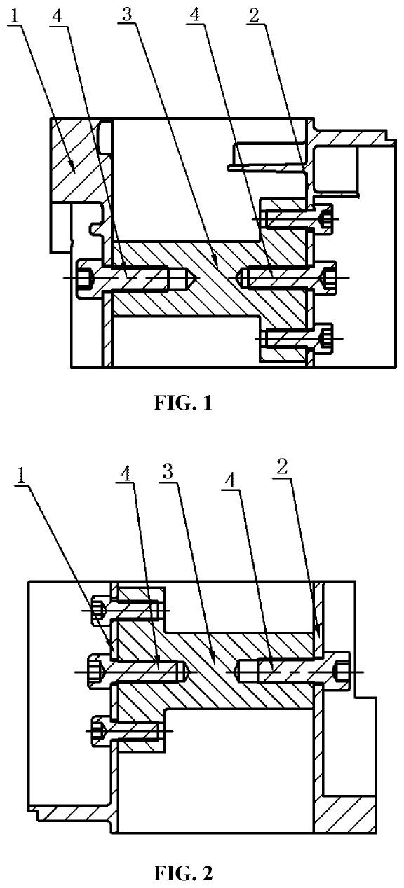

As shown in FIG. 1 to FIG. 5, the connecting column 3 is provided in the cavity structure and detachably or partially detachably connected between the front casing 2 and the rear casing 1. The connection mode of the connecting column 3 with the front casing 2 and the rear casing 1 is bolt connection or integrated casting. The connecting column 3 is used to improve the connection strength of the reducer casing structure, reduce the casing vibration and improve the NVH (noise, vibration and harshness) performance of the reducer.

The shape of the connecting column 3 may be a cylinder, a cuboid, a cube or other shape. The position of the connecting column 3 in the cavity structure may be set according to the structure of the reducer. The connecting column 3 can improve the connection strength between the front casing 2 and the rear casing 1 of the reducer, reduce the deformation of the front casing 2 and the rear casing 1 of the reducer during operation to a certain extent, and improve the NVH performance of the reducer. Moreover, the reducer casing structure is easy to install and occupies less space.

In an embodiment, as shown in FIG. 1 and FIG. 2, two ends of the connecting column 3 are connected and fixed with the front casing 2 and the rear casing 1 respectively through one or more bolts 4. When the connecting column 3 is connected and fixed with the front casing 2 or the rear casing 1 through a plurality of bolts 4, the contact area between the connecting column 3 and the front casing 2 or the rear casing 1 is larger, which is convenient for the fixing of a plurality of bolts 4.

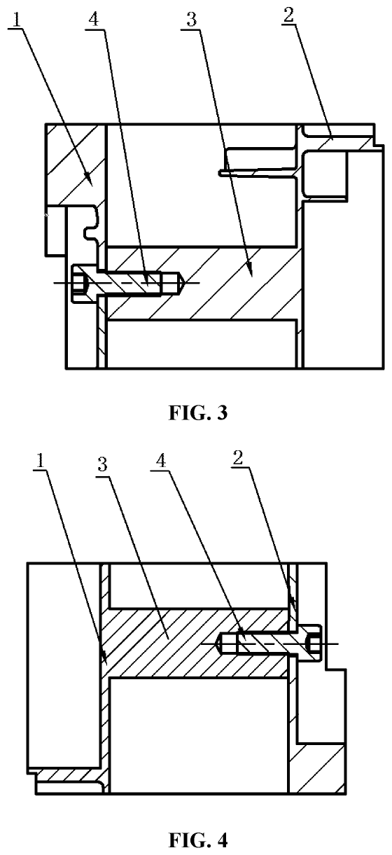

In an embodiment, as shown in FIG. 3 and FIG. 4, the connecting column 3 is integrally cast with one of the front casing 2 and the rear casing 1, and is connected and fixed with the other through one or more bolts 4.

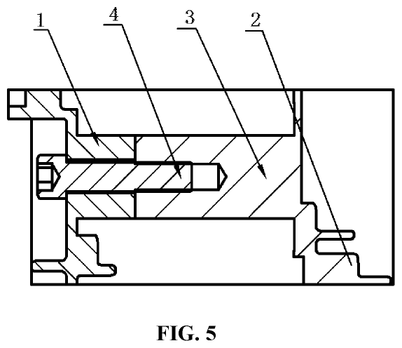

In an embodiment, as shown in FIG. 5, the connecting column 3 includes at least two sections, which are cast integrally with the front casing 2 and the rear casing 1 respectively, and the sections of the connecting column 3 are connected and fixed to each other by one or more bolts 4. When the connecting column 3 includes two sections, the two sections are cast integrally with the front casing 2 and the rear casing 1 respectively, and then the two sections of connecting column 3 are connected and fixed by bolts 4.

In an embodiment, the connecting column 3 is made of an alloy. When the connecting column 3 and the gearbox casing are integrally cast, the material of the connecting column 3 is the same as that of the gearbox casing. When the connecting column 3 and the gearbox casing are connected by bolts 4, the material of the connecting column 3 may be the same as that of the gearbox casing or be other alloys.

In an embodiment, the alloy is any one of alloy steel, aluminum alloy and copper alloy. Of course, considering the factors such as cost, connection strength and vibration reduction, the alloy steel is preferred.

In an embodiment, several connecting columns 3 may be provided. By providing a plurality of connecting columns 3 at appropriate positions in the cavity structure, the strength and vibration reduction performance of the casing structure are further improved.

In an embodiment, the connecting column 3 is of a stepped shape, which facilitates the connection of a plurality of bolts and increases the contact areas with the front and rear casings.

In an embodiment, as shown in FIGS. 1-4, the bolt 4 is inserted into the front casing 2 or the rear casing 1 and the connecting column 3 from the outside of the front casing 2 or the rear casing 1. Preferably, the bolt 4 is also provided with an anti-falling structure to prevent the bolt from falling off during the operation of the reducer.

In an embodiment, the front casing 2 and the rear casing 1 are provided with flanges perpendicular to the front casing or the rear casing at their sealed connection. The flanges are connected and fixed by bolts and nuts. The flanges can be provided at any position of the casing structure along its length and provided around the casing structure, so as to facilitate sealing and fixed connection.

In sum, the present disclosure provides a reducer casing structure comprising: a front casing, a rear casing and a connecting column; the front casing and the rear casing are sealedly connected to form therein a cavity structure for accommodating a reducer; the connecting column is provided in the cavity structure and is detachably or partially detachably connected between the front casing and the rear casing, the connection mode of the connecting column with the front casing and the rear casing is bolt connection or integrated casting, the connecting column is used to improve connection strength of the reducer casing structure, reduce casing vibration and improve NVH performance of the reducer. The reducer casing structure according to the present disclosure, by providing a connecting column between the front casing and the rear casing, increases the connection strength of the reducer casing, effectively reduces the vibration of the reducer casing, reduces the deformation of the front casing and the rear casing of the reducer during operation to a certain extent, and improves the NVH of the reducer itself or the whole power assembly; moreover, the reducer casing structure is easy to install and occupies less space.

The above are only the specific embodiments of the present disclosure. Under the above teaching of the present disclosure, those skilled in the art can make other improvements or modifications on the basis of the above embodiments. Those skilled in the art should understand that the above specific description only better explains the purpose of the present disclosure, and the protection scope of the present disclosure should be subject to the protection scope of the claims.

1. A reducer casing structure, characterized by comprising: a front casing, a rear casing and a connecting column;
the front casing and the rear casing are sealedly connected to form therein a cavity structure for accommodating a reducer;
the connecting column is provided in the cavity structure and is detachably or partially detachably connected between the front casing and the rear casing, the connection mode of the connecting column with the front casing and the rear casing is bolt connection or integrated casting, the connecting column is used to improve connection strength of the reducer casing structure, reduce casing vibration and improve NVH performance of the reducer.

2. The reducer casing structure according to claim 1, wherein two ends of the connecting column are connected and fixed with the front casing and the rear casing respectively through one or more bolts.

3. The reducer casing structure according to claim 1, wherein the connecting column is integrally cast with one of the front casing and the rear casing, and is connected and fixed with the other through one or more bolts.

4. The reducer casing structure according to claim 1, wherein the connecting column includes at least two sections which are integrally cast with the front casing and the rear casing respectively, and the sections of the connecting column are connected and fixed to each other by one or more bolts.

5. The reducer casing structure according to claim 1, wherein the connecting column is made of an alloy.

6. The reducer casing structure according to claim 5, wherein the alloy is any one of alloy steel, aluminum alloy and copper alloy.

7. The reducer casing structure according to claim 1, wherein one or more connecting columns are provided.

8. The reducer casing structure according to claim 1, wherein the connecting column is of a stepped shape.

9. The reducer casing structure according to claim 1, wherein the bolt is inserted into the front casing or the rear casing and the connecting column from outside of the front casing or the rear casing.

10. The reducer casing structure according to claim 1, wherein the front casing and the rear casing are provided with flanges perpendicular to the front casing or the rear casing at their sealed connection, and the flanges are connected and fixed by bolts and nuts.

11. The reducer casing structure according to claim 2, wherein one or more connecting columns are provided.

12. The reducer casing structure according to claim 3, wherein one or more connecting columns are provided.

13. The reducer casing structure according to claim 4, wherein one or more connecting columns are provided.

14. The reducer casing structure according to claim 5, wherein one or more connecting columns are provided.

15. The reducer casing structure according to claim 2, wherein the connecting column is of a stepped shape.

16. The reducer casing structure according to claim 3, wherein the connecting column is of a stepped shape.

17. The reducer casing structure according to claim 2, wherein the bolt is inserted into the front casing or the rear casing and the connecting column from outside of the front casing or the rear casing.

18. The reducer casing structure according to claim 3, wherein the bolt is inserted into the front casing or the rear casing and the connecting column from outside of the front casing or the rear casing.

19. The reducer casing structure according to claim 2, wherein the front casing and the rear casing are provided with flanges perpendicular to the front casing or the rear casing at their sealed connection, and the flanges are connected and fixed by bolts and nuts.

20. The reducer casing structure according to claim 3, wherein the front casing and the rear casing are provided with flanges perpendicular to the front casing or the rear casing at their sealed connection, and the flanges are connected and fixed by bolts and nuts.
